(19) United States
(12) Patent Application Publication
(10) Pub. No.: US 2007/0099594 A1
(43) Pub. Date: May 3, 2007

(54) Computer-implemented method, system, and program product for tracking a location of a user of a wireless device in a public network environment

(75) Inventors: Jonghae Kim, Fishkill, NY (US); Moon J. Kim, Wappingers Falls, NY (US); Eric C. Yee, Los Angeles, CA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/266,508

(22) Filed: Nov. 3, 2005

(51) Int. Cl. H04M 11/04

(52) U.S. Cl. 455/404.2

(57) ABSTRACT

Under the present invention, when a wireless device user is authenticated by a provider of wireless connectivity, certain information is communicated from the wireless device to a server maintained in the location of the user. Such information includes, among other things, information identifying the location of the wireless device. This information is typically maintained in a table or the like. After a data connection has been established with a public network, the information will be communicated to the provider of the public network and will be used thereby to track the location of the wireless device and/or user. In addition, the provider of the public network can query the server when updates to the information are desired. At this or any other time, the wireless device can be queried for any such updates.

### CROSS-REFERENCE TO RELATED APPLICATION

This application is related in some aspects to commonly assigned application Ser. No. (to be provided), which is assigned attorney docket number END920050122US1, is entitled Computer-Implemented Method, System, and Program Product for Tracking a Location of a User of a Wireless Device is a Private Network Environment, and was filed (to be provided).

### FIELD OF THE INVENTION

In general, the present invention relates to location tracking for a wireless device user. Specifically, the present invention provides a computer-implemented method, system, and program product for tracking a location of a user of a wireless device in a public network environment

### BACKGROUND OF THE INVENTION

As wireless/mobile devices become more pervasive, the availability of wireless network connections has steadily risen. For example, today, many public places (e.g., parks, shopping malls, coffee shops, etc.) have wireless “hotspots” whereby wireless device users can obtain Internet connections. This growing trend has allowed many workers to become more mobile and perform their job functions outside of the office. Unfortunately, as convenient as the rise of wireless technology has been, it has become very difficult to track the physical location of mobile workers. At any one time, such workers could be in a variety of locations and/or regions of the world.

Existing technology for tracking such individuals relies on Global Positioning System (GPS) technology. Under such technology, each wireless device must be equipped with a GPS tracking device in order to be tracked. There is currently no approach that allows a location of a wireless device user to be tracked in a wireless network environment. In view of the foregoing, there exists a need to overcome the afore-mentioned deficiencies in the existing art.

### SUMMARY OF THE INVENTION

In general, the present invention provides a computer-implemented method, system, and program product for tracking a location of a user of a wireless device in a public network environment. Specifically, under the present invention, when a wireless device user is authenticated by a provider of wireless connectivity, certain information is communicated from the wireless device to a server maintained in the location of the user. Such information includes, among other things, information identifying the location of the wireless device. This information is typically maintained in a table or the like.

After a data connection has been established with a public network, the information will be communicated to the provider of the public network and will be used thereby to track the location of the wireless device and/or user. In addition, the provider of the public network can query the server when updates to the information are desired. At this or any other time, the wireless device can be queried for any such updates.

A first aspect of the present invention provides a computer-implemented method for tracking a location of a user of a wireless device in a public network environment, comprising: receiving a connection request from the wireless device; establishing a data connection between the wireless device and a public network in response to the connection request; receiving information from the wireless device, wherein the information identifies the location of the user; and communicating the information to a provider of the public network, wherein the location of the user is tracked by the provider of the public network based on the information.

A second aspect of the present invention provides a system for tracking a location of a user of a wireless device in a public network environment, comprising: a system for querying the wireless device for information that identifies the location of the user; a system for receiving the information from the wireless device; a system for receiving a query from a provider of a public network with which the wireless device has established a data connection; and a system for communicating the information to the provider of the public network in response to the query, wherein the location of the user is tracked by the provider of the public network based on the information.

A third aspect of the present invention provides a system for tracking a location of a user of a wireless device in a public network environment, comprising: a system for querying for the location of the user from a provider of a public network; a system for receiving information in response to the query, wherein the information corresponds to the location of the user based on the wireless device; a system for managing the information for the provider of the public network; and a system for tracking the location of the user based on the information.

A fourth aspect of the present invention provides a program product stored on a computer readable medium for tracking a location of a user of a wireless device in a public network environment, the computer readable medium comprising program code for causing a computer system to perform the following steps: querying the wireless device for information that identifies the location of the user; receiving the information from the wireless device; receiving a query from a provider of a public network with which the wireless device has established a data connection; and communicating the information to the provider of the public network in response to the query received from the provider of the public network, wherein the location of the user is tracked by the provider of the public network based on the information.

A fifth aspect of the present invention provides a program product stored on a computer readable medium for tracking a location of a user of a wireless device in a public network environment, the computer readable medium comprising program code for causing a computer system to perform the following steps: querying for the location of the user from a provider of a public network; receiving information in response to the query, wherein the information corresponds to the location of the user based on the wireless device; managing the information for the provider of the public network; and tracking the location of the wireless device user based on the information.

A sixth aspect of the present invention provides a method for deploying an application for tracking a location of a user of a wireless device in a public network environment, comprising: providing a computer infrastructure being operable to: receive a connection request from the wireless device; establish a data connection between the wireless device and a public network in response to the connection request; receive information, wherein the information identifies the location of the user; and communicate the information to a provider of the public network, wherein the location of the user is tracked by the provider of the public network based on the information.

A seventh aspect of the present invention provides computer software embodied in a propagated signal for tracking a location of wireless device user in a public network environment, the computer software comprising instructions for causing a computer system to perform the following steps: querying the wireless device for information that identifies the location of the user; receiving the information from the wireless device; receiving a query from a provider of a public network with which the wireless device has established a data connection; and communicating the information to the provider of the public network in response to the query received from the provider of the public network, wherein the location of the user is tracked by the provider of the public network based on the information.

An eighth aspect of the present invention provides computer software embodied in a propagated signal for tracking a location of wireless device user in a public network environment, the computer software comprising instructions for causing a computer system to perform the following steps: querying for the location of the user from a provider of the public network; receiving information in response to the query, wherein the information corresponds to the location of the user based on the wireless device; managing the information for the provider of the public network; and tracking the location of the wireless device user based on the information.

The present invention also provides various computer-methods, systems, and program products for managing the information (e.g., in a table or the like), and for tracking a location of the wireless device user based on the information.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts the authentication of a wireless device user with a wireless connectivity provider according to the present invention.

FIG. 2 depicts the tracking of the wireless device user in a public network environment according to the present invention.

FIG. 3 depicts an information table as used to track the location of the wireless device user according to the present invention.

FIG. 4 depicts a more specific computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### BEST MODE FOR CARRYING OUT THE INVENTION

For convenience purposes, the Best Mode for Carrying Out the Invention will have the following sub-sections:
I. General Description
II. Illustrative Embodiment
III. Computerized Implementation
   I. General Description

As indicated above, the present invention provides a computer-implemented method, system, and program product for tracking a location of a user of a wireless device in a public network environment. Specifically, under the present invention, when a wireless device user is authenticated by a provider of wireless connectivity, certain information is communicated from the wireless device to a server maintained in the location of the user. Such information includes, among other things, information identifying the location of the wireless device. This information is typically maintained in a table or the like.

After a data connection has been established with a public network, the information will be communicated to the provider of the public network and will be used thereby to track the location of the wireless device and/or user. In addition, the provider of the public network can query the server when updates to the information are desired. At this or any other time, the wireless device can be queried for any such updates.

II. Illustrative Embodiment

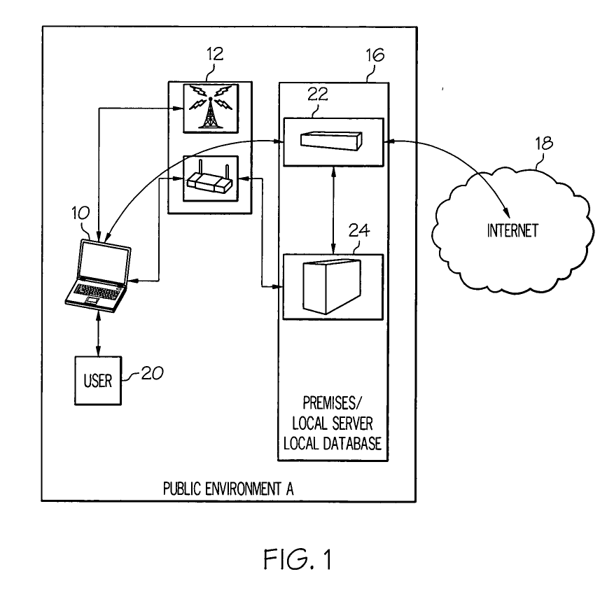

A typical embodiment of the present invention will now be described in conjunction with FIGS. 1-3. In this embodiment, it is assumed that a wireless device user is attempting to obtain a wireless connection to a public network such as the Internet. It is further assumed that the wireless network user is in a location where wireless access is provided such as a coffee shop. Referring to FIG. 1, this scenario is shown in greater detail. Specifically, as shown, FIG. 1 depicts a wireless device 10 (mobile client) attempting to establish a data connection with a public network 18 while located on a particular premises 16. To establish the data connection, a user 20 of wireless device 10 will form an association with a wireless connectivity provider 12 and then be authenticated through standard techniques such as a username and password. The data connection can then be established with public network 18 through the premises 16.

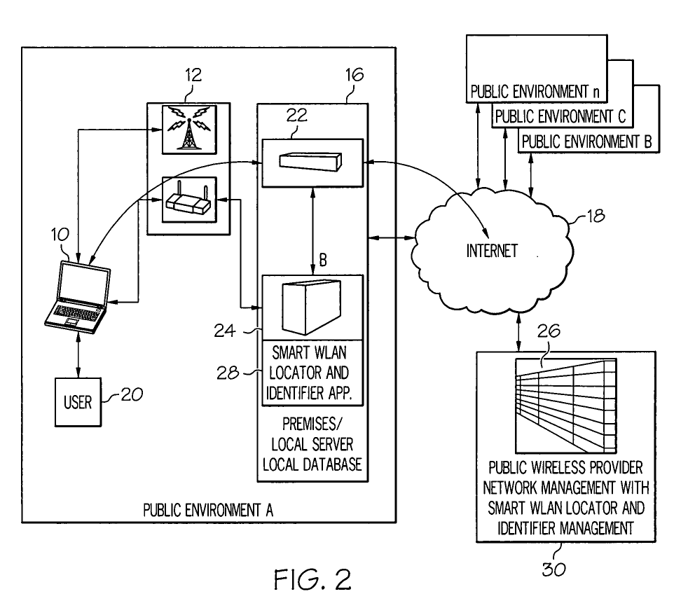

As further shown, premises 16 maintains a switch 22 and a (local) server 24. These resources will be leveraged under the present invention to provide real-time location information about user 20. Referring to FIG. 2, this is shown in greater detail. As shown in FIG. 2, server 24 and provider 26 of public network 18 both maintain “counter-part” locator applications. Specifically, server 24 includes premises locator application 28, while provider 26 maintains provider locator application 30, respectively.

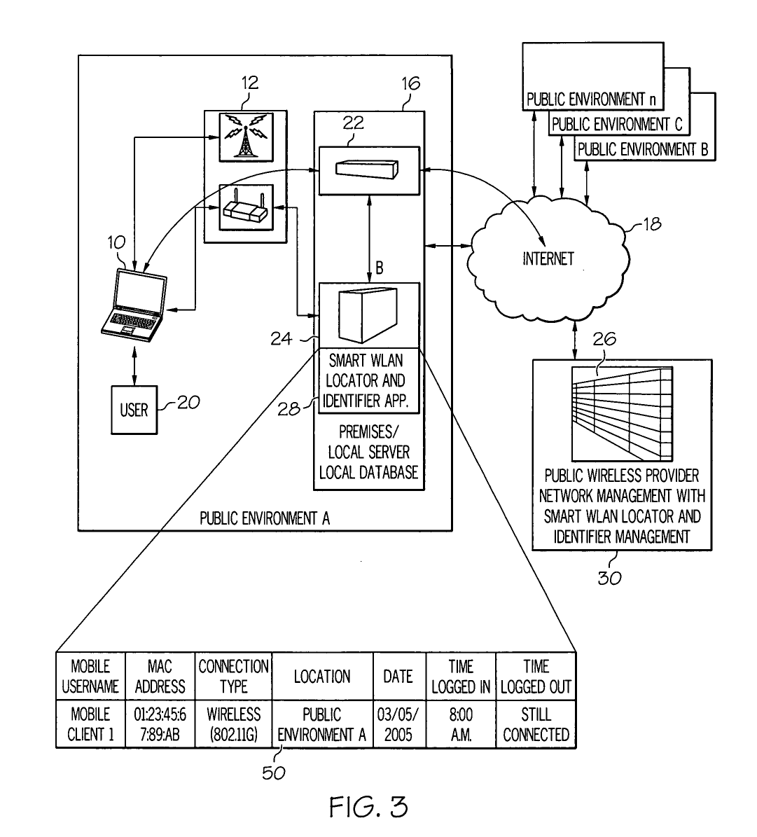

These applications 28 and 30 will be used to track the location of user 20 based on (the location of) wireless device 10. Specifically, after user 20 is authenticated with provider of wireless connectivity 12, information that identifies a location of user 20 will be communicated to server 24. Such information typically includes: a Media Access Control (MAC) address corresponding to the wireless device 10, a location corresponding to server 24 (e.g., identifying the public environment of premises 16), a timestamp corresponding to a data connection being established between wireless device 10 and public network 18, a name corresponding to wireless device 10, a connection type corresponding to the data connection, and a date corresponding to the date of the data connection. This information typically represents real-time information in that when it is gathered, it represents the most current information for wireless device 10. Moreover, this information is maintained in a table or the like on server 24 (and/or switch 22) and will be managed on server by premises locator application 28. Referring to FIG. 3, an illustrative table 50 in which the information is maintained is shown in greater detail.

Referring back to FIG. 2, a data connection will be established between wireless device 10 and public network 18 via switch 22 and server 24. After the connection has been established, premises locator application 28 will communicate the “location” information to provider locator application 30. Similar to premises locator application 28, provider locator application 30 will maintain (e.g., in a table) and manage the information. Provider 26 can use this information to track the location of user 20.

Under the present invention, the information is updated on server 24 and provider 26 to ensure accuracy. Specifically, premises locator application 28 has the capability to send a query (on-demand or on a predetermined schedule) to wireless device 10 for updated information. When wireless device 10 receives such a query, it will communicate updated information to server 24. Similarly, provider locator application 30 has the capability to send a query to server 24 for updated information. The query will be received and processed by premises locator application 28. In response, updated information will be communicated to provider 26 for receipt and management by provider application 30.

It should be understood that premises locator application 28 has the capability to query wireless device 10 or not whether or not it received a query from provider locator application 30. That is, premises locator application 28 need not wait for a query from premises locator application 30 to query wireless device 10. In any event the information is used to track the physical location of user 20. Moreover, since the information represents real-time information, it can be relied upon for accuracy. Still yet, public environments B-N have been depicted to illustrate that the present invention can be implemented in any type of public environment and/or in multiple public environments at once.

III. Computerized Implementation

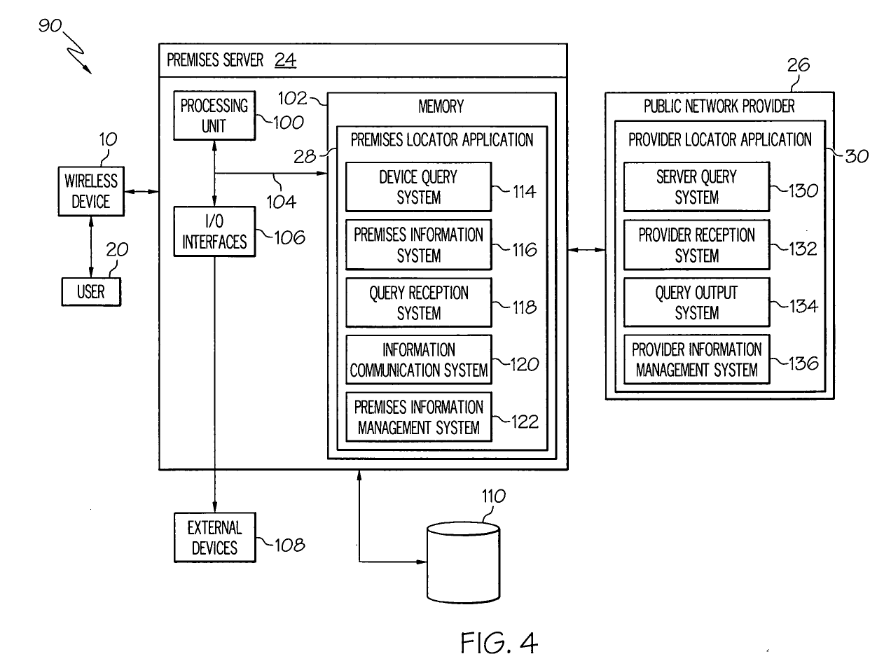

Referring now to FIG. 4, a more detailed computerized implementation 90 of the present invention is shown. As depicted, implementation 90 depicts wireless device 10, operated by user 20, in communication with premises server 24. Further, premises server 24 is in communication with provider 26. It should be understood that some of the components (e.g., public network 18, switch 22, etc.) of FIGS. 2 and 3 have been omitted from FIG. 4 for brevity purposes only.

In any event, the components of present invention typically communicate via any combination of various types of network-based communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, any of the components of the present invention could be deployed, managed, serviced, etc. by a service provider who offers to track a location of a wireless device user in a public network environment.

As further shown, premises server 24 includes a processing unit 100, a memory 102, a bus 104, and input/output (I/O) interfaces 106. Further, premises server 24 is shown in communication with external I/O devices/resources 108 and storage system 110. In general, processing unit 100 executes computer program code, such as premises locator application 28, which is stored in memory 102 and/or storage system 110. While executing computer program code, processing unit 100 can read and/or write data to/from memory 102, storage system 110, and/or I/O interfaces 106. Bus 104 provides a communication link between each of the components in premises server 24. External devices 108 can comprise any devices (e.g., keyboard, pointing device, display, etc.) that enable a user to interact with premises server 24 and/or any devices (e.g., network card, modem, etc.) that enable premises server 24 to communicate with one or more other computing devices.

Premises server 24 is only representative of various possible computer systems that can include numerous combinations of hardware and/or software. To this extent, in other embodiments, premises server 24 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 100 may comprise a single processing unit, or be distributed across one or more processing units in one or more locations, e.g., on a client and server. Similarly, memory 102 and/or storage system 110 can comprise any combination of various types of data storage and/or transmission media that reside at one or more physical locations. Further, I/O interfaces 106 can comprise any system for exchanging information with one or more external devices 108. Still further, it is understood that one or more additional components (e.g., system software, math co-processing unit, etc.) not shown in FIG. 4 can be included in premises server 24. However, if premises server 24 comprises a handheld device or the like, it is understood that one or more external devices 108 (e.g., a display) and/or storage system 110 could be contained within premises server 24, not externally as shown.

Storage system 110 can be any type of system (e.g., a database) capable of providing storage for information under the present invention such as location information, etc. To this extent, storage system 110 could include one or more storage devices, such as a magnetic disk drive or an optical disk drive. In another embodiment, storage system 110 includes data distributed across, for example, a local area network (LAN), wide area network (WAN) or a storage area network (SAN) (not shown). Although not shown, additional components, such as cache memory, communication systems, system software, etc., may be incorporated into premises server 24. Moreover, it should be understood that although not shown for brevity purposes, wireless device 10, provider 26, etc. will include computerized components similar to provider 26.

Shown in memory 102 of premises server 24 is premises locator application 28, which includes a device query system 114, a premises information system 116, a query reception system 118, an information communication system 120, and a premises information management system 122. Similarly, shown within public network provider 26 (e.g., presumably loaded in computer memory as well), is provider locator application 30, and which includes server query system 130, provider reception system 132, query output system 134, provider information management system 136, and tracking system 138. The applications 28 and 30 collaborate to provide the functions of the present invention as described above. Specifically, assume that user 20 is seeking a wireless data connection to a public network provided by provider 26 and has already been authenticated with a wireless connectivity provider. At such a time, the “location” information described above (e.g., MAC address, time stamp, etc.) will be gathered and communicated to premises server 24. The information will be received by premises information system 116 and managed in a table or the like by premises information management system 122. In addition, information communication system 26 will communicate the information to provider 26.

On provider 26, provider reception system 132 will receive the information, which will be managed in a table or the like by provider information management system 136. As indicated above, both premises locator application 28 and provider locator application 30 have the capability to query for updated information. In the case of the former, device query system 114 of premises locator application 28 will query wireless device 10 for an update, which will be received by premises information system 116 and used by premises information management system 122 to update the table. Similarly, when provider 26 desires an update, server query system 130 of provider locator application 30 will generate a query that is outputted by query output system 134, and is received by query reception system 118 of premises locator application 28. In response, device query system 114 can query wireless device 10 for an update. Whether or not wireless device 10 is queried at that time, the information as maintained on premises server 24 will be communicated by information communication system 120 to provider 26 (e.g., received by provider reception system 132 and used to update the provider's table by provider information management system 136). At any time, tracking system 138 can access the information in table to track the location of user 20.

While shown and described herein as a method, system and program product for tracking a location of a wireless device user in a public network environment, it is understood that the invention further provides various alternative embodiments. For example, in one embodiment, the invention provides a computer-readable/useable medium that includes computer program code to enable a computer infrastructure perform the functions of the present invention. To this extent, the computer-readable/useable medium includes program code that implements each of the various process steps of the invention. It is understood that the terms computer-readable medium or computer useable medium can comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 102 (FIG. 4) and/or storage system 110 (FIG. 4) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to track a location of a wireless device user in a public network environment. In this case, the service provider can create, maintain, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for tracking a location of a wireless device user in a public network environment. In this case, a computer infrastructure can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as premises server 24 (FIG. 4), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A computer-implemented method for tracking a location of a user of a wireless device in a public network environment, comprising:
receiving a connection request from the wireless device;
establishing a data connection between the wireless device and a public network in response to the connection request;
receiving information from the wireless device, wherein the information identifies the location of the user; and
communicating the information to a provider of the public network, wherein the location of the user is tracked by the provider of the public network based on the information.

2. The computer-implemented method of claim 1, wherein the information is maintained in a table and comprises a Media Access Control (MAC) address corresponding to the wireless device, a location corresponding to a server, and a timestamp corresponding to the data connection.

3. The computer-implemented method of claim 2, wherein the information further comprises a name corresponding to the wireless device, a connection type corresponding to the data connection, and a date corresponding to the data connection.

4. The computer-implemented method of claim 1, further comprising:
querying the wireless device, wherein the information is received in response to the querying; and
receiving a query from the provider of the public network, wherein the information is communicated to the provider of the public network in response to the query from the provider of the public network.

5. The computer-implemented method of claim 1, wherein the information is real-time information.

6. The computer-implemented method of claim 1, wherein the information is maintained in a table by the provider of the public network, and wherein the method further comprises tracking a location of the user based on the table.

7. The computer-implemented method of claim 1, further comprising authenticating the wireless device user before the data connection with the public network is established.

8. A system for tracking a location of a user of a wireless device in a public network environment, comprising:
a system for querying the wireless device for information that identifies the location of the user;
a system for receiving the information from the wireless device;
a system for receiving a query from a provider of a public network with which the wireless device has established a data connection; and
a system for communicating the information to the provider of the public network in response to the query, wherein the location of the user is tracked by the provider of the public network based on the information.

9. The system of claim 8, further comprising a system for managing the information for the provider of the public network.

10. The system of claim 8, further comprising:
a system for outputting the query from the provider of the public network;
a system for receiving the information by the provider of the public network;
a system for managing the information for the provider of the public network; and
a system for tracking the location of the wireless device user based on the information.

11. The system of claim 8, wherein the information comprises a Media Access Control (MAC) address corresponding to the wireless device, a location corresponding to a server, and a timestamp corresponding to the data connection.

12. The system of claim 11, wherein the information further comprises a name corresponding to the wireless device, a connection type corresponding to the data connection, and a date corresponding to the data connection.

13. The system of claim 8, wherein the information received from the wireless device is real-time information.

14. A system for tracking a location of a user of a wireless device in a public network environment, comprising:
a system for querying for the location of the user from a provider of a public network;
a system for receiving information in response to the query, wherein the information corresponds to the location of the user based on the wireless device;
a system for managing the information for the provider of the public network; and
a system for tracking the location of the user based on the information.

15. The system of claim 14, wherein the information comprises a Media Access Control (MAC) address corresponding to the wireless device, a location corresponding to a server, and a timestamp corresponding to a data connection.

16. The system of claim 15, wherein the information further comprises a name corresponding to the wireless device, a connection type corresponding to the data connection, and a date corresponding to a data connection.

17. A program product stored on a computer readable medium for tracking a location of a user of a wireless device in a public network environment, the computer readable medium comprising program code for causing a computer system to perform the following steps:
querying the wireless device for information that identifies the location of the user;
receiving the information from the wireless device;
receiving a query from a provider of a public network with which the wireless device has established a data connection; and
communicating the information to the provider of the public network in response to the query received from the provider of the public network, wherein the location of the user is tracked by the provider of the public network based on the information.

18. The program product of claim 17, the computer readable medium further comprising program code for performing the following step: managing the information on a server at the location.

19. A program product stored on a computer readable medium for tracking a location of a user of a wireless device in a public network environment, the computer readable medium comprising program code for causing a computer system to perform the following steps:
querying for the location of the user from a provider of a public network;
receiving information in response to the query, wherein the information corresponds to the location of the user based on the wireless device;
managing the information for the provider of the public network; and
tracking the location of the wireless device user based on the information.

20. A method for deploying an application for tracking a location of a user of a wireless device in a public network environment, comprising:
providing a computer infrastructure being operable to:
receive a connection request from the wireless device;
establish a data connection between the wireless device and a public network in response to the connection request;
receive information, wherein the information identifies the location of the user; and
communicate the information to a provider of the public network, wherein the location of the user is tracked by the provider of the public network based on the information.
